(19) United States
(12) Patent Application Publication
(10) Pub. No.: US 2019/0312497 A1
(43) Pub. Date: Oct. 10, 2019

(54) FERROMAGNETIC CORE TOROID MOTOR AND GENERATOR

(71) Applicant: Raymond James Walsh, Island Park, ID (US)

(72) Inventor: Raymond James Walsh, Island Park, ID (US)

(21) Appl. No.: 16/443,711

(22) Filed: Jun. 17, 2019

Related U.S. Application Data
(63) Continuation-in-part of application No. 15/878,236, filed on Jan. 23, 2018, now Pat. No. 10,340,768.
Application No. 15/878,236 is a continuation-in-part of application No. 16/215,585, filed on Dec. 10, 2018.
Application No. 16/215,585 is a continuation-in-part of application No. 16/190,072, filed on Nov. 13, 2018, now Pat. No. 10,326,343.
(60) Provisional application No. 62/814,742, filed on Mar. 6, 2019.
(60) Provisional application No. 62/596,376, filed on Dec. 8, 2017.
(60) Provisional application No. 62/596,376, filed on Dec. 8, 2017.
(60) Provisional application No. 62/596,376, filed on Dec. 8, 2017.

(51) Int. Cl. H02K 21/14; H02K 11/21; H02K 11/30

(52) U.S. Cl. CPC H02K 21/145; H02K 2201/12; H02K 11/30; H02K 11/21

(57) ABSTRACT

A motor includes a number of individual electric coils arranged in the shape of a toroid around a ferromagnetic core, and configured so that, upon the application of electric current through the plurality of individual coils, the stator generates a rotating magnetic field within the ferromagnetic core. The motor also includes a magnetic rotor having a number of individual magnets positioned on the rotor such that adjacent magnets alternate in magnetic orientation, and are configured to direct magnetic flux lines through the stator. Further, the motor includes a controller configured for controlling the distribution of electric current to said plurality of individual electric coils. A generator may be similarly constructed, where the rotor is mechanically rotated to induce an electric current through the individual electric coils.

### CROSS-REFERENCE TO RELATED APPLICATIONS

This application claims benefit of U.S. provisional patent application No. 62/814,742, filed Mar. 6, 2019, and is a continuation-in-part of co-pending U.S. non-provisional patent application Ser. No. 15/878,236, filed Jan. 23, 2018, which will issue as U.S. Pat. No. 10,340,768 on Jul. 2, 2019, and which claims benefit of U.S. provisional patent application No. 62/596,376, filed Dec. 8, 2017, and is a continuation-in-part of co-pending U.S. non-provisional patent application Ser. No. 16/215,585, filed Dec. 10, 2018, which claims benefit of U.S. provisional patent application No. 62/596,376, filed Dec. 8, 2017, and is a continuation-in-part of co-pending U.S. non-provisional patent application Ser. No. 16/190,072, filed Nov. 13, 2018, which claims benefit of U.S. provisional patent application No. 62/596,376, filed Dec. 8, 2017, the disclosures of which are hereby incorporated by reference in their entireties.

Conventional rotary coil motors are well-known and have been in existence for well over a century, the basic design feature being a rotor ring with ferromagnetic elements passing through a series of stator coils arranged in a circle. Various methods for transfer of torque have been employed, most commonly using a system of gears, chains, or pulleys. These devices, however, have not enjoyed widespread use.

Subsequent designs and improvements sought to transfer torque by magnetically coupling across a magnetically permeable sealed housing. This advance enabled the movement of fluids without contact between the fluids and vulnerable elements within the motor. Examples include a machine for moving wet cement, another for moving coolant within a nuclear reactor, and a centrifugal pump design.

More recent developments replace the ferromagnetic elements (iron elements, which are not magnetic, but which respond to magnetic forces) within the rotor with permanent magnets. Whereas a ferromagnetic element can only be attracted into a coil, a permanent magnet can be simultaneously repelled out of one coil and attracted into the next, provided that the magnetic poles are arranged favorably with respect to the coils. A typical permanent magnet/coil motor incorporates a rotor ring comprising a series of magnets arranged in alternating polarity with spaces or non-magnetic elements between the magnets. This rotor passes through an interrupted series of coils, the interruptions between the coils being necessary for mechanical transfer of power between the rotor and the powertrain. U.S. Pat. No. 6,252,317 to Scheffer et al. discloses such a commutated electric motor with a plurality of permanent magnets on a rotor which passes through coil stators. In this device, torque is transferred by means of teeth on the rotor engaging multiple gear wheels.

Generators, which could be described as the converse of electric motors, also suffer from similar inherent inefficiencies and deficiencies. For example, U.S. Pat. Pub. 2012/0235528A1 to Axford teaches a toroidal inductance generator employing magnets within a toroidal copper coil being induced to move by magnetically coupled magnets external to the coil attached to an internal combustion motor. Design limitations, however, preclude this generator from also functioning as a motor.

The Halbach Motor and Generator, U.S. Pat. No. 9,876,407, discloses a motor and generator that includes two magnetically coupled, coaxially-nested Halbach cylinder rotors, one of which passes through a toroidal series of at least two stator coils while the other is attached to an axle or other means of transferring mechanical power. Adjacent stator coils are configured so as to produce opposing magnetic fields upon energizing of the motor. Alternating the current to the stator coils induces movement in the rotor. A method of torque transfer between the magnetically coupled rotors is also disclosed.

Co-pending U.S. non-provisional patent application Ser. No. 15/878,236, discloses a flywheel energy storage device that includes a dual-rotor toroid coil motor/generator which employs continuously variable torque transfer via magnetic induction. The primary and rotors are coaxial and double-nested. Each rotor includes magnet arrays that focus magnetic flux towards the other, resulting in magnetic coupling of the rotors. The stator rotates within a toroid-shaped series of coils. Three-phase motor control is disclosed. Rolling biphasic motor control is also disclosed, which includes dividing the motor/generator coils into increments, then energizing groups of contiguous increments into virtual coils, which revolve in tandem with the magnetic rotors so as to achieve continuous and optimal torque.

Magnetic reluctance is defined as the resistance to the flow of magnetic flux through a magnetic circuit as determined by the magnetic permeability and arrangement of the materials of the circuit. A magnetic circuit may include magnets and ferromagnetic elements, such as iron or ferrite or steel. Magnetic permeability can be thought of as the ability of a material to allow passage of magnetic flux. It is analogous to the concept of conductivity in electricity. Iron, for instance, has a high magnetic permeability whereas air has low magnetic permeability. Magnetic flux will pass through air, just as an electric spark will cross an air gap, but flux passes much more readily through iron.

The components comprising a magnetic circuit tend to act in such a way as to facilitate the flow of magnetic flux through the circuit, and thus minimize reluctance. This principle is most famously illustrated in Tesla's Switched Reluctance Motor. This motor uses an iron or ferromagnetic rotor to form a magnetic circuit with electromagnets. The ferromagnetic rotor is made to rotate between electromagnets of opposite polarity (stator coils). The rotor is compelled to rotate in order to complete a magnetic circuit through the rotor and stator coils. At the point in the rotation where magnetic flux flows most readily, the magnetic circuit is said to be in a state of minimal reluctance. A series of stator coils are configured in a circle, directing magnetic flux inward towards the ferromagnetic rotor. Successively switching the polarity of the stator coils just ahead of the rotating rotor enables continued rotation. Although the Switched Reluctance Motor employs electromagnets, the reluctance principle also applies to magnetic circuits comprising permanent magnets. Tesla's Switched Reluctance Motor thus uses magnetic reluctance as a means of inducing rotor movement in contrast to the Halbach Motor/Generator, which uses magnetic reluctance as a means of coupling rotors so as to facilitate torque transfer.

Iron has a microscopic structure composed of magnetic domains, each of which acts like a tiny magnet. In non-magnetized iron, these magnetic domains are randomly oriented in all directions so as to cancel one another. When a piece of iron is placed near a magnet, these magnetic domains temporarily align with the magnet, thus creating an attraction between the iron and the magnet. Magnets have a north and a south magnetic pole, with magnetic field lines emanating from the north pole and diving back into the south pole. A piece of iron is attracted to a magnet regardless of which pole is nearest the iron. The reason is that the magnetic domains within the piece of iron will always orient along the magnetic field lines so as to create an attractive force. So when the north pole of a magnet is placed near a piece of iron, the microscopic magnetic domains within the iron will align and cause the portion of the iron nearest the magnet to become a south pole. Once the magnet is removed from proximity of the iron, these domains return to their baseline chaotic and random orientations. In this way, a magnet held near a piece of iron will temporarily magnetize the iron.

Similar behavior is observed when an electromagnet is placed near a piece of iron or other ferromagnetic material. A solenoid is an electromagnet coil in a housing that receives a ferromagnetic plunger. Regardless of the electric polarity supplied to the coil, the plunger is only attracted into the solenoid when the coil is energized. The magnetic domains within the plunger always orient with the magnetic field lines produced by the coil so as to create an attractive force. The energized solenoid coil thus induces the plunger to become a temporary virtual magnet that only attracts into the coil regardless of electric polarity. Once power is cut off to the coil, the magnetic domains of the plunger return to their previous randomly oriented states and the virtual coil ceases to exist.

### SUMMARY OF THE INVENTION

The ferromagnetic reluctance-coupled motor and generator employs a toroid-shaped ferromagnetic stator core fabricated from thin silicon or electrical steel laminations, or other ferromagnetic material with low hysteresis and high magnetic permeability.

The ferromagnetic core resides within a series of coils also arranged in the shape of a toroid. A controller delivers Alternating Current (AC) to the coils so that adjacent coil groups generate magnetic fields that alternate in polarity. The ferromagnetic stator is magnetically coupled to a magnetic rotor that rotate outside the coils. The magnetic rotor includes an array of magnets alternating north/south in magnetic polarity and configured to direct magnetic flux towards the stator. These flux lines pass through the ferromagnetic core of the stator so as to complete magnetic circuits with the alternating rotor magnets. These magnetic circuits alternate clockwise/counterclockwise around the circumference of the ferromagnetic stator core.

The stator is configured to generate a rotating and alternating magnetic field within the ferromagnetic core. This rotating magnetic field couples with the permanent magnetic fields of the magnetic rotor and thereby induce rotation in the rotor. Thus electric energy supplied to the stator coils induces a mechanical torque in the magnetic rotor. This torque may be further transferred to any number of machine elements including a drive shaft, propeller, or wheel.

The disclosed machine may also function as a generator. Mechanical torque received by the magnetic rotor from a shaft will induce rotation of the magnetic rotor, which in turn generates a rotating magnetic field in the ferromagnetic stator core. This generates electricity in the coils which may be directed via a controller towards an electrical load.

Another embodiment employs an induction cylinder deposed between the stator and the rotor. The induction cylinder is made of an electrically conducting material like copper or aluminum. Movement of rotor magnetic fields in proximity to the induction cylinder will induce a circular electric current wholly contained within the induction cylinder as per Lenz's Law. This induced current will give rise to a magnetic field of its own emanating from the induction cylinder. The induced magnetic fields of the induction cylinder attract the magnetic fields of the rotor magnet assembly, and this induces rotation of the induction cylinder to move in the same direction as the rotor.

Importantly, the reverse is also true. Rotating the induction cylinder in proximity to the magnet assembly will induce the magnet assembly to move in similar fashion as the induction cylinder.

The degree to which torque is transferred between the magnet assembly and the induction cylinder depends on several factors. These factors include the relative rotational rate, the strength of the magnetic fields, the conductivity of the induction cylinder, and the mass or thickness of the conductor. A thicker-walled induction cylinder will affect greater torque transfer than a thin-walled cylinder. Copper is an excellent conductor and will affect high torque transfer. Titanium, a poor conductor, will affect a lesser torque transfer. For cost considerations, aluminum might be sufficient, or perhaps an alloy of copper.

The degree of torque transfer also depends on the extent of the overlap between the induction cylinder and the cylindrical magnet assembly. The greater the depth of insertion, the more the magnet assembly bathes the conductor in magnetic flux, and the more torque is transferred.

The induction cylinder may have a graduated thickness to modulate and optimize the torque transfer curve. One end of the cylinder may be thinner relative to the other end. The variations in cylinder thickness may be continuous or stepped, or both. Cooling fins attached to the induction cylinder will mitigate the accumulation of heat.

The stator coil assembly includes a series of coils arranged in the shape of a toroid and aligned end to end so as to allow the rotation of the stator through each coil. In one embodiment, the stator assembly and control are achieved as described in the Halbach Motor and Generator, U.S. Pat. No. 9,876,407.

In another embodiment, Rolling Biphasic Coil Control is employed to control and energize the stator coils as outlined in co-pending parent U.S. non-provisional patent application Ser. No. 15/878,236.

### BRIEF DESCRIPTION OF THE DRAWINGS

FIGS. 1A, 1B, and 1C are sectional schematic depicting progressive rotor rotation and coil energizing according to embodiments of the invention.

FIG. 2 is a schematic diagram exemplifying a magnet cylinder coupled to a coaxial ferromagnetic core that may be used in embodiments of the invention.

FIGS. 3A, 3B, 3C, and 3D are cross-sectional views showing progressive penetration of the induction cylinder into the gap between stator and rotor that may occur when using embodiments of the invention.

FIG. 4 illustrates an embodiment of the invention in which the magnet rotor is positioned side by side with the stator.

### DETAILED DESCRIPTION OF THE INVENTION

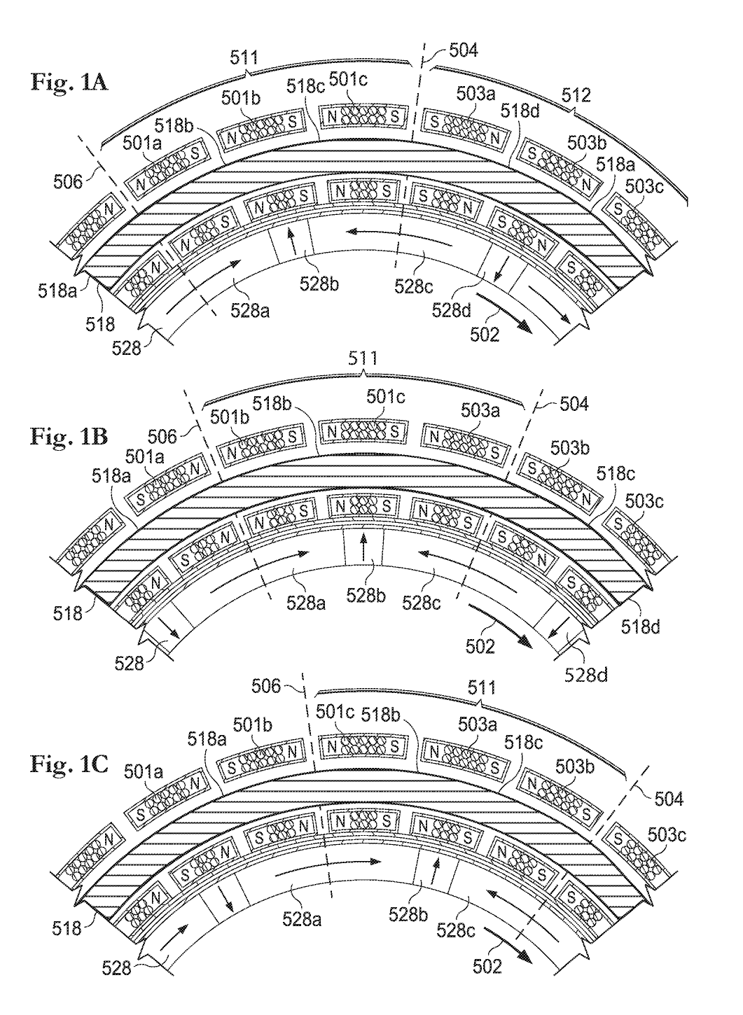

Referring to FIGS. 1A-1C of the drawings. The stator includes ferromagnetic core 518 surrounded by stator coils 501a-501c and 503a-503c configured for 3-phase coil control. Magnet rotor 528 is shown in a first position. The stator comprises coil groups of three contiguous coils. Coils 501a, 501b, and 501c constitute one group, and coils 503a, 503b, and 503c constitute an adjacent coil group. This configuration allows for the application of three-phase alternating current to three separate circuits each offset by 120 degrees. Coils 501a and 503a are configured on a first circuit, coils 501b and 503b are configured on a second circuit, and coils 501c and 503c are configured on a third circuit. When appropriately driven by three-phase alternating current, this three-phase configuration creates a revolving magnetic field within ferromagnetic core 518, which induces rotation of magnet rotor 528. This embodiment does not require auxiliary mechanisms to initiate rotation of magnet rotor 528 from a dead stop.

FIGS. 1A-1C also illustrate a novel form of motor control called Rolling Biphasic Coil Control, in which individual coils are energized into groups. Coil group 511 of FIG. 1A includes three individual coils 501a-501c, and coil group 512 includes three individual coils 503a-503c. These coil groups are temporary, and comprise three adjacent coil elements all energized with the same polarity to emulate a single large coil having a length equal to the sum of the lengths of the individual coils within a coil group. Coil groups in this embodiment include three increment coils, but may be subdivided into four or more coil increments per group as may be required for the particular implementation. These coil groups are assigned by the motor controller to emulate an equivalent larger or virtual coil. Coil groups may also be called virtual coils, and include a group of adjacent coils each generating a magnetic field of the same polarity, and having the opposite polarity of the next adjacent virtual coil.

As magnet rotor 528 rotates, its position is sensed by a sensor that continuously updates the controller, and that continuously reconfigures coil groups to advance just ahead of the magnet rotor to facilitate continued rotation of the magnet rotor. In FIG. 1B, coil group 511 now includes individual coils 501b, 501c, and 503a, whereas coil group 512 now includes individual coils 503b, 503c, and 501c (not illustrated). The advancement of coil grouping induces a clockwise rotation of magnet rotor 528 as viewed in FIG. 1B.

Further rotation of primary rotor 518 occurs as illustrated in FIG. 1C, which demonstrates a new coil group configuration that has rolled clockwise. Coil group 511 now comprises individual coils 501c, 503a, and 503b, which all have the same N/S polarity. This new coil group configuration further advances the rotating magnetic field within ferromagnetic core 518, which induces further clockwise rotation of magnet rotor 528.

Alternatively, an embodiment may function in reverse as an electrical generator. Rotation of magnet rotor 128 induces a rotating magnetic field in ferromagnetic core 118. This rotating magnetic field creates a flow of electricity within the coils of stator 511 and 512. A controller (not show) reconfigures coil groups in tandem with the rotating magnet rotor to optimize delivery of electricity to a load.

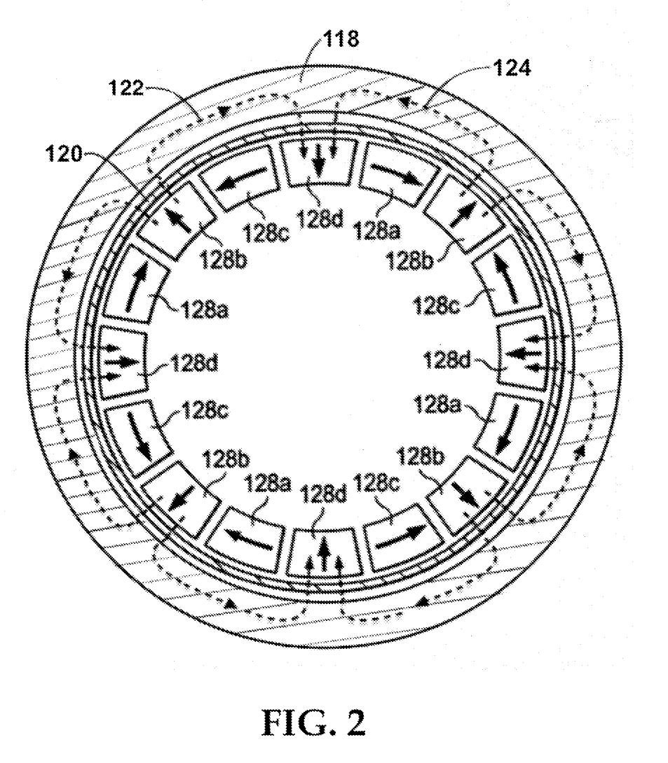

FIG. 2 is a schematic illustration of the interaction between magnet rotor 128, illustrated by its component pieces 128a, 128b, a28c, and 128d, as well as ferromagnetic core 118. Magnetic circuit 122 includes a portion of ferromagnetic core 118, as well as component pieces 128d, 128c, and 128b. Magnetic circuit 124 includes a portion of ferromagnetic core 118, as well as component pieces 128d, 128a, and 128b. These magnetic circuits pass through induction cylinder 120 made of electrically conducting metal such as copper or aluminum.

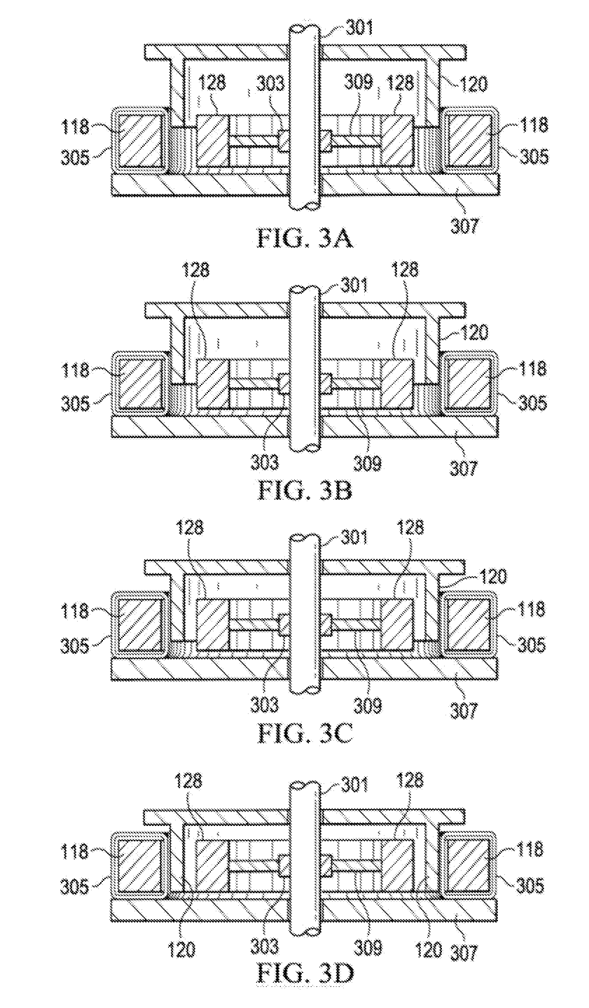

The embodiment of FIGS. 3A-3D employ a second method of magnetic torque transfer called magnetic induction torque transfer, and involves the insertion of an induction cylinder, fabricated from electrically conductive material, into the gap between the stator and the rotor. Magnetic induction torque transfer (MITT) transfers torque via magnetic fields induced in a cylinder fabricated from copper, aluminum, or some other electrically conductive material in accordance with Lenz's Law of Induction.

As illustrated in FIG. 3A, a stator attached to plate 307 includes ferromagnetic core 118 surrounded by toroid core 305. Magnetic induction cylinder 120 attached to shaft 301 is interposed between ferromagnetic core 118 and magnet rotor 128. Bearing 303 allows magnetic rotor 128 to rotate relative to shaft 301.

Magnetic induction cylinder 120 is fabricated from an electrically conductive material, such as copper or aluminum. When magnetic induction cylinder 120 is at rest relative to the coupled rotors 118 and 128, no force exists on the magnetic induction cylinder 120. Movement of magnetic induction cylinder 120 relative to coupled rotors 118 and 128 generates an electrical current within magnetic induction cylinder 120, in accordance with Lenz's law of induction. The electrical current, contained completely within the conductor of the cylinder 120, induces a magnetic field of its own. The induced magnetic field contained within the magnetic induction cylinder 120 results in a magnetic attraction, and torque transfer, between the magnetic induction cylinder 120 and the coupled magnet rotor 128 and ferromagnetic core 118, resulting in torque transfer. The MITT method of torque transfer between magnetic induction cylinder and coupled magnetic arrays increases the efficiency of the energy transfer.

The degree of torque transfer between induction cylinder 120 and magnet rotor 128 depends on the extent of insertion of the induction cylinder into the gap between the magnetic rotor and the stator. FIG. 3A depicts an embodiment in which induction cylinder 120 is minimally inserted adjacent to magnet rotor 128. In this position, the magnetic interaction between magnet rotor 128 and induction cylinder 120 is minimal, therefore torque transfer between the two is minimal. As induction cylinder 120 is further inserted as shown in FIG. 3B, there is greater interaction between the induction cylinder and the magnet rotor, and therefore greater torque transfer. FIG. 3C illustrates nearly full insertion of the induction cylinder, while FIG. 3D illustrates full insertion of the induction cylinder 120 into the gap between the magnetic rotor and the stator, and thus imparts optimal torque transfer between magnet rotor 128 and induction cylinder 120.

Shaft 301 may be attached to a drivetrain that includes a propeller or wheels. Shaft 301 may also be incorporated within an induction braking system designed to slow the rotation of magnetic rotor 128 relative to the stator.

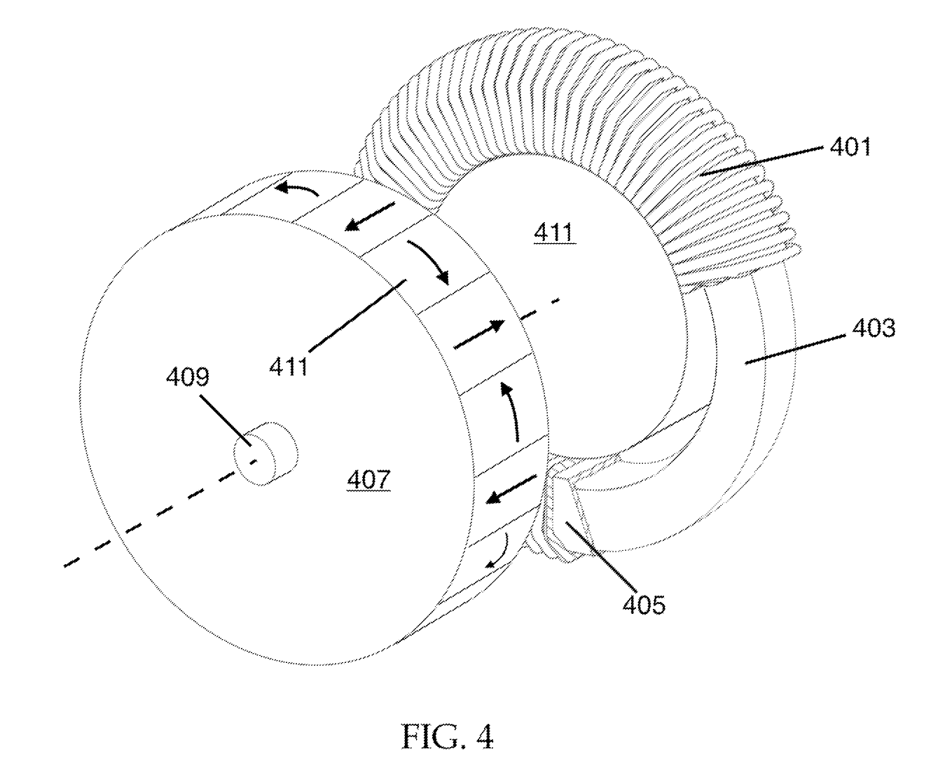

FIG. 4 illustrates an embodiment in which magnet rotor 407 is side by side with stator 411. In this embodiment, magnet rotor 407 lies on a parallel geometric plane with stator 411.

Magnet rotor 407 is attached to shaft 409, and includes cylindrical magnet array 411. Stator 411 includes a toroid-shaped ferromagnetic core 403 fabricated from thin silicon or electrical steel laminations, or other ferromagnetic material with low hysteresis and high magnetic permeability. This core is wrapped in an electrical insulator 405, in turn surrounded by coil assembly 401.

When energized, energizing coil assembly 401 will induce a rotating magnetic field in ferromagnetic core 403. This will in turn induce rotation of coupled magnet rotor 407. Torque is transferred via shaft 409 to a drivetrain which may include a propeller, wheels, or other mechanical system.

Alternatively, as in previous embodiments, the embodiment of FIG. 4 may function in reverse as a generator. Torque received by shaft 409 induces rotation of magnet rotor 407, which in turn induces a rotating magnetic field in ferromagnetic core 403. This rotating magnetic field creates a flow of electricity within the coils of stator 411.

Throughout this specification, unless the context requires otherwise, the word “comprise” and variations such as “comprises”, “comprising” and “comprised” are to be understood to be used in their open-ended form, meaning the presence of a stated element or group of elements but not the exclusion of any other element or group of elements.

Throughout this specification, unless the context requires otherwise, the word “include” and variations such as “includes”, or “including” are to be understood to be used in their open-ended form, meaning the presence of a stated element or group of elements but not the exclusion of any other element or group of elements.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

What is claimed is:

1. A motor comprising:
a plurality of individual electric coils arranged in the shape of a toroid and configured so that, upon the application of electric current through the plurality of individual coils, adjacent individual coils generate magnetic fields of opposing polarities;
a stator fabricated from ferromagnetic material positioned within the plurality of electric coils;
a magnetic rotor including a plurality of individual magnets positioned on the rotor
such that adjacent magnets alternate in magnetic orientation, said magnets configured to direct magnetic flux lines through said stator; and
a controller configured for controlling the distribution of electric current to said plurality of individual electric coils.

2. The motor of claim 1, wherein said controller distributes electric current to said plurality of individual electric coils in a rolling biphasic configuration, said individual coils configured as groups comprising two or more adjacent coils, said adjacent coils connected in series such that said coil groups provide a virtual coil such that as said rotor spins, said controller selectively reconfigures and energizes each coil group so as to continuously urge rotation of said rotor.

3. The motor of claim 1, further comprising a sensor, wherein said sensor is positioned to determine the location of said rotor in relation to said plurality of electric individual coils, wherein said sensor is configured to communicate said position of said rotor to said controller.

4. The motor of claim 1, wherein said rotor includes a drive shaft.

5. The motor of claim 1, wherein said controller is configured to conduct three phase alternating electric current.

6. The motor of claim 1, further comprising an induction cylinder coaxial with the magnetic rotor and having a circumference smaller than an internal circumference of the magnetic rotor, or larger than an external circumference of the magnetic rotor, the induction cylinder disposed adjacent the magnetic rotor and positioned for relative rotation through magnetic flux lines emanating from the magnetic rotor.

7. The motor of claim 6, further comprising an actuator configured to move the induction cylinder relative to the magnetic rotor.

8. The motor of claim 6, in which the induction cylinder is coupled to a means of mechanical torque transfer that has an axis of rotation through the center of the magnetic rotor.

9. The motor of claim 6, in which the induction cylinder is a metal cylinder.

10. A generator comprising:
an armature comprising a plurality of individual electric coils arranged in the shape of a toroid, said armature further comprising a core fabricated from ferromagnetic material positioned within the plurality of individual electric coils;
a magnetic rotor including a plurality of individual magnets positioned on the rotor such that adjacent magnets alternate in magnetic orientation, said magnets configured to direct magnetic flux lines through said stator, said rotor configured to receive mechanical torque so that upon receipt of said torque the rotation of said rotor causes a rotating magnetic field to pass through said armature; and
a controller configured to direct electric current from said plurality of electric coils to a load.
